(19) United States
(12) Patent Application Publication
(10) Pub. No.: US 2025/0095096 A1
(43) Pub. Date: Mar. 20, 2025

(54) OFFICER-IN-THE-LOOP CRIME REPORT GENERATION USING LARGE LANGUAGE MODELS AND PROMPT ENGINEERING

(71) Applicant: Oracle International Corporation, Redwood Shores, CA (US)

(72) Inventors: Iman Zadeh, Los Angeles, CA (US); Christophe J. Gerard, Arlington, MA (US); Qiu Qin, Centreville, VA (US); Ziqun Ye, Menlo Park, CA (US); Aditya Banerjee, Danville, CA (US); Jun Qian, Bellevue, WA (US); Nicole E. Hess, Ocean City, MD (US)

(21) Appl. No.: 18/885,192

(22) Filed: Sep. 13, 2024

Related U.S. Application Data
(60) Provisional application No. 63/538,760, filed on Sep. 15, 2023.

(51) Int. Cl. G06Q 50/26; G06F 40/197; G06F 40/40

(52) U.S. Cl. CPC G06Q 50/265; G06F 40/197; G06F 40/40

(57) ABSTRACT

The present disclosure relates to utilizing large language models (LLMs) to facilitate generation of incident reports or similar documents. One or more initial inputs may be received from a user, and one or more example incident reports may be identified. The one or more example incident reports and the one or more initial inputs may be sent to an LLM. A reviewable version of an incident report may be accessed that is based on output that the LLM generated based on the example incident reports and the one or more initial inputs. The reviewable version of the incident report may be presented in a human readable format via a graphical user interface (GUI). A modification corresponding to the reviewable version of the incident report may be received via the GUI. The modification and the reviewable version of the incident report may be sent to the LLM to cause the LLM to generate an updated version of the incident report.

### BENEFIT CLAIM

This application claims the benefit of Provisional Application 63/538,760, filed Sep. 15, 2023, the entire contents of which is hereby incorporated by reference as if fully set forth herein, under 35 U.S.C. § 119 (e).

### TECHNICAL FIELD

The present disclosure relates to use of large language model (LLM)-based mechanisms to facilitate creation of incident reports (e.g., police reports, insurance reports).

### BACKGROUND

Following any incident or police officer dispatch, it is imperative for law enforcement personnel to consult their notes and generate a comprehensive report within a computerized system. This report encompasses various aspects of the incident, including event specifics, interviews conducted, suspect information, and a description of the crime scene, among other details. This process demands a significant investment of time and effort from officers. While recent advancements, such as auto-completion and OCR technology, have offered some assistance to officers in these tasks, they remain inadequate.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of an example system utilizing large language models (LLMs) to facilitate generation of incident reports or similar documents.

FIG. 2 is a block diagram of a semantic search agent that can be utilized to provide prompts to an LLM for report generation.

FIG. 3 is an example report that can be generated using the approaches described.

FIG. 4 illustrates an example prompt to generate a first version of a report.

FIG. 5 illustrates an example prompt to generate a second version of a report using a context learning approach.

FIG. 6 illustrates an example first version of a report generated using the approach described.

FIG. 7 illustrates an example first version of a report with corresponding feedback and inputs to generate a second version of the report.

FIG. 8 illustrates an example prompt to generate a second version of the report based on an edited first version of the report and edited input fields.

FIG. 9 illustrates a first version of a report and a second version of the report based on the first version of the report and changes to input fields.

FIG. 10 is a flow diagram for an example approach to generating a report utilizing an LLM.

FIG. 11 is a block diagram that illustrates a computer system upon which an embodiment of the invention may be implemented.

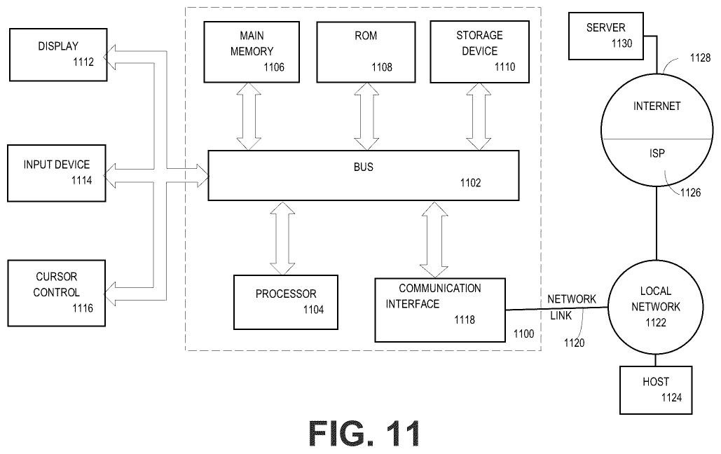

FIG. 12 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

In the current era marked by the proliferation of large language models (LLMs) and generative artificial intelligence (AI), the approaches described herein a complete system for facilitating generation of incident (or similar) reports. The systems described can empower officers to harness the capabilities of extensive language models for report generation and allow them to refine these reports in real-time as necessary.

The approaches described provide a pioneering approach by harnessing the potential of large language models (LLMs) for the creation of police reports (or similar documents, for example, insurance reports). The example approaches described integrates feedback from police officers (or other report generators) directly into the report, enhancing its accuracy and relevance The approaches described may employ an architecture in which natural language serves as the interface for communication between various cells (both for input and output). To support this approach, one or more elements, including the implementation of few-shot learning and semantic search, may be utilized. These elements supply context and examples, guiding the LLM to generate reports effectively. Using LLM in this way may help to expedite the adoption of Machine Learning (ML) in safety-critical applications. The use of natural language for input and output in these complex Al/ML algorithms can hasten the acceptance and trust in this technology. Additionally, the disclosed approaches offer the flexibility of transitioning to an offline mode where human operators can either take over or supplement the generative Al tasks, thereby enhancing the scalability and availability of the overall system.

### SYSTEM OVERVIEW

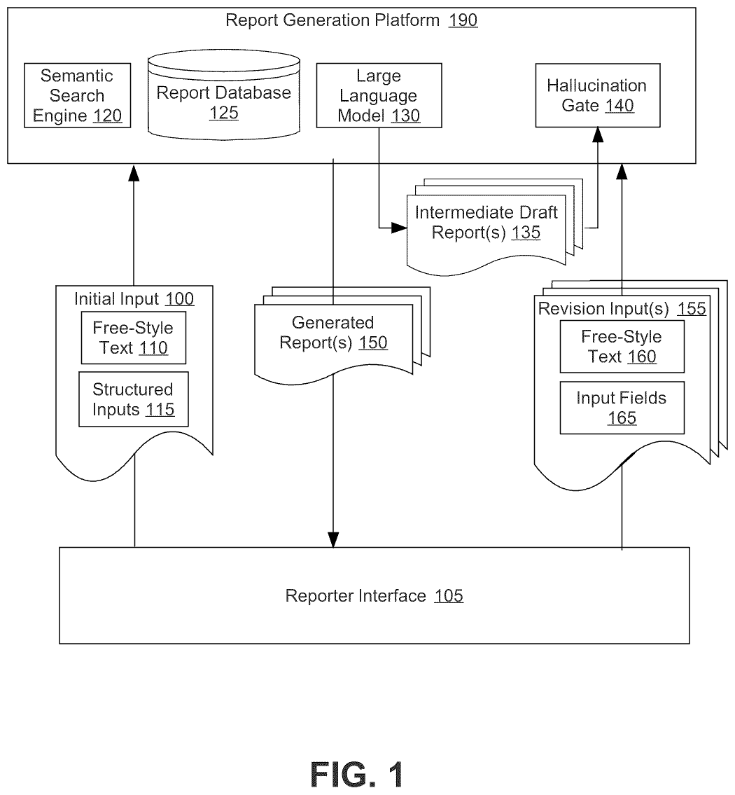

FIG. 1 is a block diagram of an example system utilizing large language models (LLMs) to facilitate generation of incident reports or similar documents. The specific example of FIG. 1 corresponds to a police report generated by a police officer. However, in other example use cases, different types of reports can be generated. These other example use cases include, but are not limited to, insurance reports generated by an insurance adjuster, incident reports generated by a school official (e.g., principal), a wildlife interaction report generated by a marine biologist or park ranger, etc.

In the example architecture of FIG. 1, report generation platform 190 can include semantic search agent 120 to provide semantic search functionality, report database 125 to provide example reports, large language model 130 to generate report contents and/or hallucination gate 140 to provide content guardrails on reports generated by LLM 130. One or more users can interact with report generation platform via one or more input/output devices (e.g., keyboard, mouse, touchscreen, non-touch screen, microphone, speaker, haptic device). The input/output devices are not explicitly illustrated in FIG. 1. In alternative examples, one or more of report database 125, semantic search agent 120, LLM 130 and hallucination gate 140 can be external report generation platform 190, and can be accessed remotely, for example, via network connection.

### Initial Input

In the example of FIG. 1, a user of a reporter interface 105 is responsible for an incident report for a previous incident. In the process of responding to the incident, the user interacts with the reporter interface 105 to generate initial input 100, which may be provided to the report generation platform 190. The initial input 100 may include free-style text 110 and structured inputs 115. The free-style text 110 may include notes or other unstructured or semi-structured text describing the incident in natural language. The free-style text 110 may be used as input to large language model (LLM) 130. In addition to the free-style text 110, the reporter interface 105 may present to the user (e.g., via a GUI) one or more input fields that can accept text entry and/or one or more fields that provide corresponding dropdown menus for selection of input values; the data from the input fields may be provided to the report generation platform 190 as structured inputs 115.

Various data preparation operations can be used to prepare input data for use by report generation platform 190. Structured data is often provided in a JSON format. If so, one or more of the following preprocessing operations can be performed: 1) flatten the nested JSON structure to make it more accessible for analysis; 2) concatenate relevant fields, such as names, addresses, and other essential information; and/or 3) apply filtering to remove fields without values to provide data cleanliness and efficiency. For unstructured data, the unstructured data can be extracted from processed structured data. This can include, for example, extracting notes, statements, and other text-based information that might not fit in structured fields.

### Semantic Search

Information from notes 110 and/or input fields 115 can be used to perform semantic search 120. The results from semantic search 120 can enable in-context learning by LLM 130, which improves overall performance in generating incident reports. In an example, the semantic search 120 may augment the relevance of prompts used by the LLM 130 to generate incident reports. In general, semantic search 120 provides LLM 130 with one or more relevant examples of the type of incident report to be generated by LLM 130. In an example, semantic search 120 can utilize report database 125 to search for reports most closely related to the type of report to be generated by LLM 130. This enhances the quality of incident reports generated by the LLM 130 by offering a more contextually precise prompt.

Semantic search 120 may involve converting the initial input 100 into embeddings using LLM 130. These embeddings capture the semantic meaning of the free-style text 110 and structured inputs 115 from the initial input 100. These embeddings may be used to identify relevant reports in the report database 125.

The semantic search 120 approach can include use of templates that store pre-calculated embeddings of structured data examples. These templates may be stored as example reports in a report database 125. This report database 125 serves as a reference bank for the semantic search 120. In an example, the semantic search 120 involves calculation of the cosine similarity between the target (the input or query for which similar content is sought) and relevant example report(s) stored in the report database 125. Other search types can also be used to provide alternative approaches. In the cosine similarity approach, the example(s) with the highest cosine similarity score are returned as the most contextually relevant result(s). This process provides retrieved content that closely aligns with the intent and context of the target input.

In an example, information from one of structure inputs 115 and/or free-style text 110 can be used to search report database 125 for the k closest examples to the incident report to be generated. In an example, multiple reports are extracted from report database 125. In general, the greater the number of reports from report database 125, the better the results from LLM 130. However, due to token size constraints, the number of reports that can be provided to LLM 130 may be relatively small (e.g., one, two, three). In an example, a centroid or clustering based analysis can be used to select results from report database 125.

The example reports from the semantic search performed by semantic search agent 120, the free-style text 110, and structured inputs 115 may be transmitted to LLM 130 to be used to create a prompt for LLM 130 to generate a draft report. The example reports provide context using which the LLM 130 may generate an incident report. In an example, instead of relying solely on zero-shot prompt engineering, semantic search agent 120 provides a small number (e.g., one, two, three, four, etc.) of examples or demonstrations to guide LLM 130 in generating contextually accurate content.

### Prompt Engineering

Prompts for LLM 130 may be constructed to guide LLM 130 in generating the desired content. A prompt structure can comprise, for instance, a general instruction to set the context for LLM 130, an example input, an example report, and target input (which can be demarcated by special characters). As described in greater detail below, prompt maturity can be provided by refining the instructions and examples provided to LLM 130 to align with the desired output.

This k-shot learning using the k closest example reports may help LLM 130 understand the desired context and reduces hallucinatory outputs. This approach to prompt engineering helps craft precise and context-rich prompts that clearly specify the desired format or context of the response to minimize the chances of irrelevant or fabricated information.

In an example, the LLM 130 may have a temperature hyperparameter-whose values can range from zero to one-set closer to one than zero. The temperature hyperparameter influences how much randomness may be present in the LLM's 130 outputs; lowering the temperature decreases the randomness, while increasing the temperature increases the randomness. The LLM 130 may then generate multiple responses, and the degree of randomness, and therefore variability, between these responses may result in an increased probability that a desirable response has been generated. The LLM 130 may employ self-voting to select a most desirable response. In an example, the LLM 130 may select a response based on a centroid of the multiple generated responses. The LLM 130 calculates the distance between each response and the other responses; the LLM 130 then selects a response that is most similar to the other responses.

In some implementations, the initial input 100 may be separated into multiple different sections. These sections may be created so that text in each section is related to one particular topic or subject matter. The LLM 130 may generate one or more response(s) using each section as input. That way, when generating a response for a single section, the LLM 130 has a specific, well-defined task that will reduce the likelihood of hallucination. In an example, the LLM 130 may generate multiple responses for each section and select the most desirable among them using the techniques described above. The selected responses for each section may then be assembled into a single response. The LLM 130 may output this single response as an intermediate draft report 135.

### Hallucination Gate

In the exemplary approach illustrated in FIG. 1, this intermediate draft report 135 is further processed by hallucination gate 140, which may analyze the intermediate draft to identify errors generated by LLM 130. Errors identified by the hallucination gate 140 may include, for example, hallucinations (factually incorrect or nonsensical output), biases, or ethical issues. Hallucination gate 140 may provide one or more post-generation filters to flag or remove content that appears to be hallucinatory from the intermediate draft report 135. In an example, hallucination gate 140 can use heuristics, blacklists, and/or pattern recognition to identify and filter out unreliable information. Hallucination gate 140 can use the context to reduce the generation of incorrect or fabricated information. The hallucination gate 140 can provide a first version of the generated report 150 as an output of report generation platform 190 to the reporter interface 105.

### Revising the Generated Report

The reporter interface 105 may present this first version of the generated report 150, for example, visually as part of a graphical user interface, audially using text to speech, or by any other desired presentation method supported by the reporter interface 105. One or more users (e.g., police officers, insurance adjusters) of the reporter interface 105 can review the first version of the generated report 150 and provide further free-style text 160 and/or structured inputs 165 as revision input 155 based on the first version of the generated report 150. The free-style text 160 and/or structured inputs 165 provided as revision input 155 may be modified compared to the free-style text 110 and structured inputs 115 provided in the initial inputs 100.

Using the first version of the generated report 150 as context (instead of or in addition to the example report(s) previously used), the LLM 130 may then generate a second version of the generated report 150 (including another intermediate draft report 135 that is processed by the hallucination gate 140) and provide the second version of the generated report 150 to the reporter device 150. The iterative revision process can continue until the report generation platform 109 generates a version of the generated report 150 that is satisfactory to the user of the user of the reporter interface 105 (and/or one or more users involved with the report generation process, such as administrative users).

As another example, when revising a version of a generated report 150 with free-style text 110, structured inputs 115, and/or other input, one or more parameters of LLM 130 can be modified to facilitate improvement in subsequent versions of the generated report 150. In an example, a variability parameter (e.g., temperature) can be reduced to improve accuracy of subsequent versions of the generated report 150. In some implementations, the temperature may be decreased each time a new version of the generated report 150 is generated following the first version.

In an example, report generation process illustrated in FIG. 1 can be applied separately to each section of a report. This may be useful because different report sections can have different requirements, styles, formats, etc. In an example of a police report, the sections can include, as examples, an offense description section, a main narrative section, a victim statement section, a supporting narrative section, a disposition section, etc. Different types of reports have different types of requirements, as appropriate.

While the examples provided herein are generally based on incident reports generated by police officers, other applications within the realm of public safety can be contemplated. Further, additional applications outside of the realm of public safety can be contemplated as well. Further, public safety examples include a network of interconnected cells utilizing LLMs within respective user feedback loops, for example, a call-taker responsible for guiding the conversation with a caller to optimize the retrieval of incident-related information, a call-taker focusing on prioritizing collected information based on relevance to an incident response plan, a call dispatcher attempting to optimize incident response plans for efficient deployment of resources, a dispatched unit tasked with generating a case report, etc.

### Semantic Search

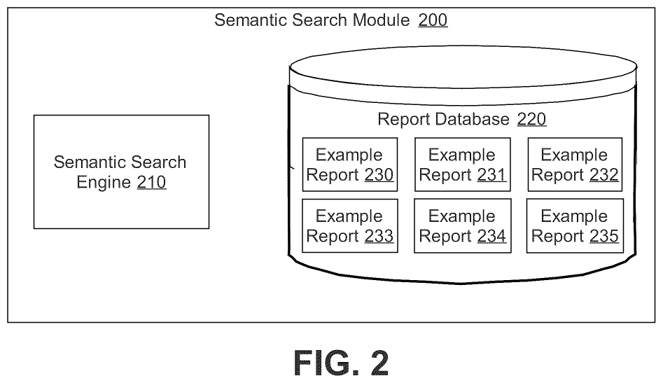

FIG. 2 is a block diagram of a semantic search module 200 that can be utilized to provide prompts to an LLM for report generation. Semantic search module 200 can provide the semantic search functionality as described with respect to FIG. 1. Semantic search agent 210 can receive inputs (e.g., free-style text 110 and/or structured inputs 115) to perform a search on report database 220. As discussed above, semantic search agent 210 can use various search strategies (e.g., cosine similarity) to find one or more reports (e.g., 230, 231, 232, 233, 234, 235) that most closely resemble the type of report to be generated. Semantic search agent 210 can use the retrieved report(s) to convert text into embeddings using Large Language Models (LLMs). These embeddings may capture the semantic meaning of the text. This may enhance the quality of generated content by offering a more contextually precise prompt. In an example, semantic search engine 210 can be implemented as a hardware processor communicatively coupled with report database 220.

In some implementations, the semantic search agent 210 may conduct a separate semantic search for each section of the incident report to be generated. In such cases, the semantic search engine 210 may, for each section of the incident report, may identify sections of one or more example reports from the report database 220 that are most relevant to the initial inputs 100 provided by the user in the reporter interface 105. For example, if the structured inputs 115 in the initial inputs 100 indicate that an incident type is “burglary”, then the semantic search agent 210 can identify example reports for “burglary” incidents. However, the semantic search agent 210 may also consider other contextual information from the initial inputs 100 to identify relevant example reports that may not be classified as “burglary”.

### Personal Identifiable Information Reduction

Police and other types of reports frequently contain sensitive Personal Identifiable Information (PII), such as names, addresses, phone numbers, dates of birth, and social security numbers. In contrast to conventional methods that simply mask PII, the approach described can employ automatic PII reduction techniques in example reports 230-235 stored in the report database 220.

In an example, this process anonymizes the sensitive data in example reports 230 by replacing it with synthetic information in a context-aware manner, preserving both semantic and syntactic properties of the data. This approach maintains the ability to link data across different sources even after PII replacement, thereby enhancing data security during model training and fine-tuning. Removing PII also streamlines the engineering and fine-tuning processes, leading to increased efficiency.

### Example Report

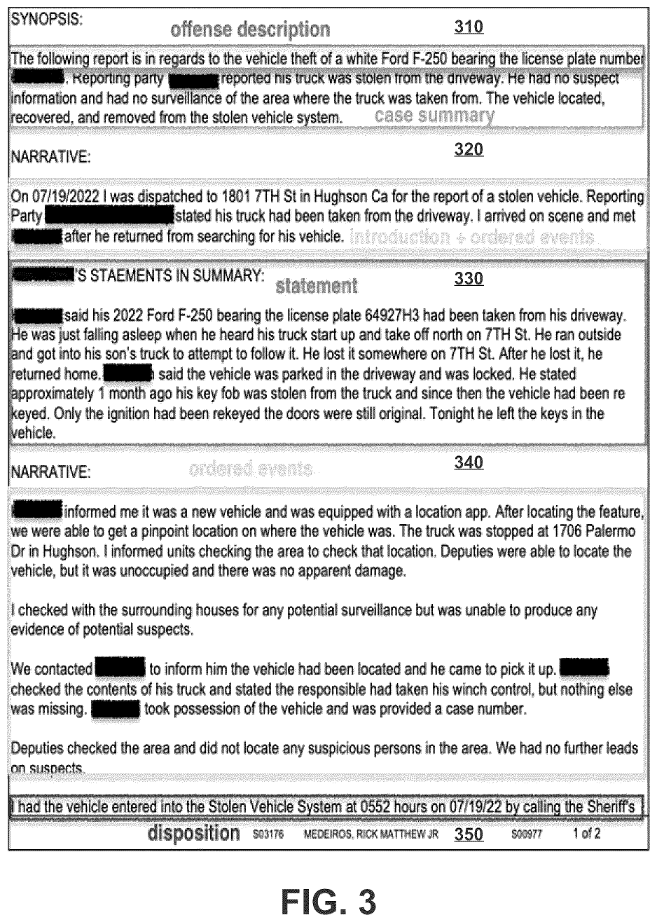

FIG. 3 is an example report that can be generated using the approaches described. The example of FIG. 3 is a police report; however, many other types of reports can be generated in a similar manner. The example police report of FIG. 3 includes the following sections: offense description 310, primary narrative 320, victim statement 330, supporting narrative 340 and disposition 350. Alternate police reports can have more and/or different sections. Other types of reports (e.g., insurance, therapeutic visit) can have different sections as appropriate. As mentioned above, each section of the report can be independently generated using the architectures as described with respect to FIG. 1 and/or FIG. 2. That is, the report generation process can be utilized to generate offense description section 310 and then again to generate primary narrative 320 and so on until all sections of the report have been generated. The various sections can be compiled to provide the final report.

### Example Output Generation

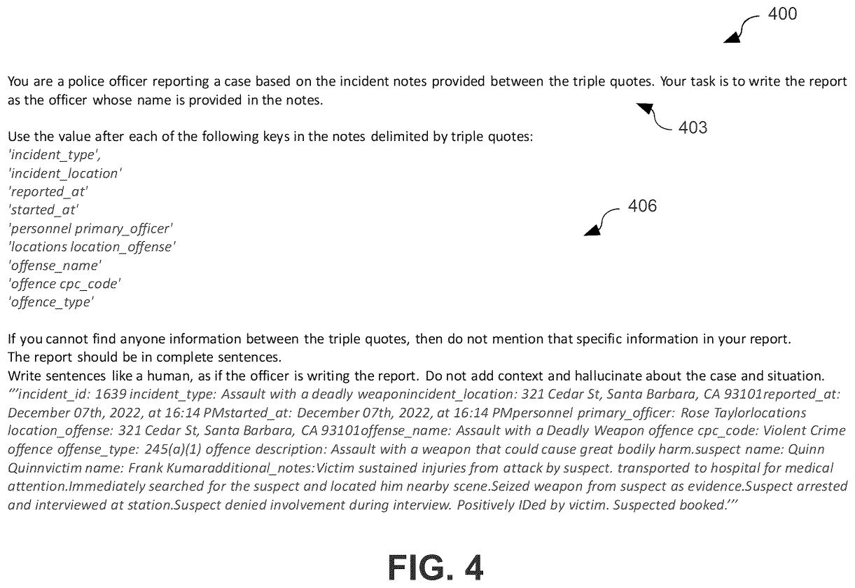

FIG. 4 illustrates an example prompt 400 to generate a first version of an incident report 150. The example of FIG. 4 is just one example of a prompt that can be used to generate a first version of a police report. Other types of police reports and/or other types of incident reports can be generated in a similar manner. The prompt 400 specifies the desired format and context of the response. The prompt 400 comprises a general instruction 403 to set the context for the LLM 130 and target input 406. The target input 406 includes the free-style text 110 and the structured inputs 115 from the initial input 100 received from the reporter interface 105.

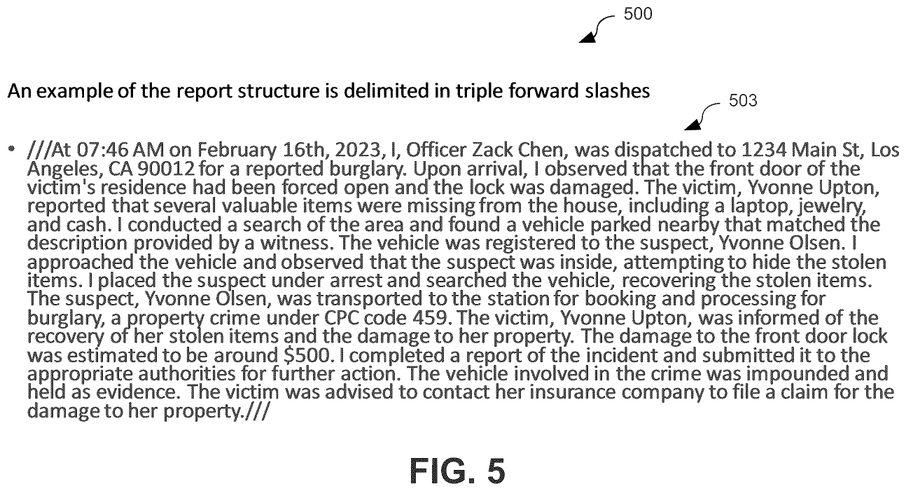

FIG. 5 illustrates an example prompt 500 to generate a second version of a generated report 150. In this example, the prompt 500 has been generated using a context learning approach. The prompt 500 as illustrated in FIG. 5 can be created using the approach as described with respect to FIG. 1. The prompt 500 includes an example report 503, such as the example reports (e.g., 230, 231, 232, 233, 234, 235) obtained by the semantic search engine 210 in FIG. 2. Inclusion of the example report 503 in the prompt 500 may provide context to improve the quality of the generated report 150 generated by the LLM 120 by providing a close example of what kind of incident report 150 the LLM 120 should generate.

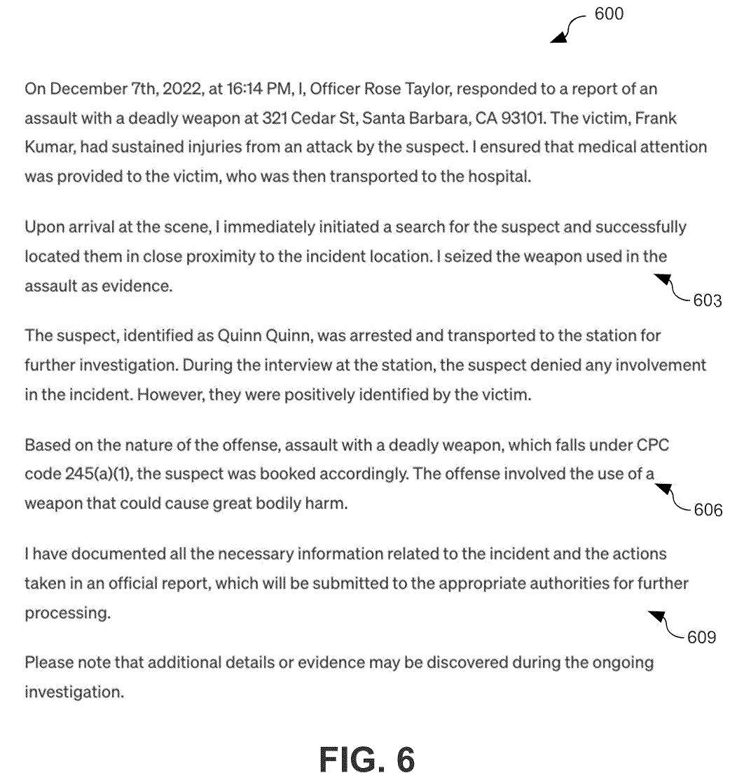

FIG. 6 illustrates an example first version 600 of a generated report 150 generated using the approach described. The example first version 600 be generated using the prompt as illustrated in FIG. 4 (or by another prompt). The first version 600 comprises several sections, including a narrative 603, an offense description 606, and a disposition 609. The narrative 600 includes a description of the circumstances and events underlying the incident of the generated report 150. The offense description 606 describes the offense that the user alleges was committed during the course of the incident, a statutory citation corresponding to the offense, and how the circumstances of the incident meet the statutory requirements for that offense. The disposition 609 describes the status of the incident at the time of the generated report 150.

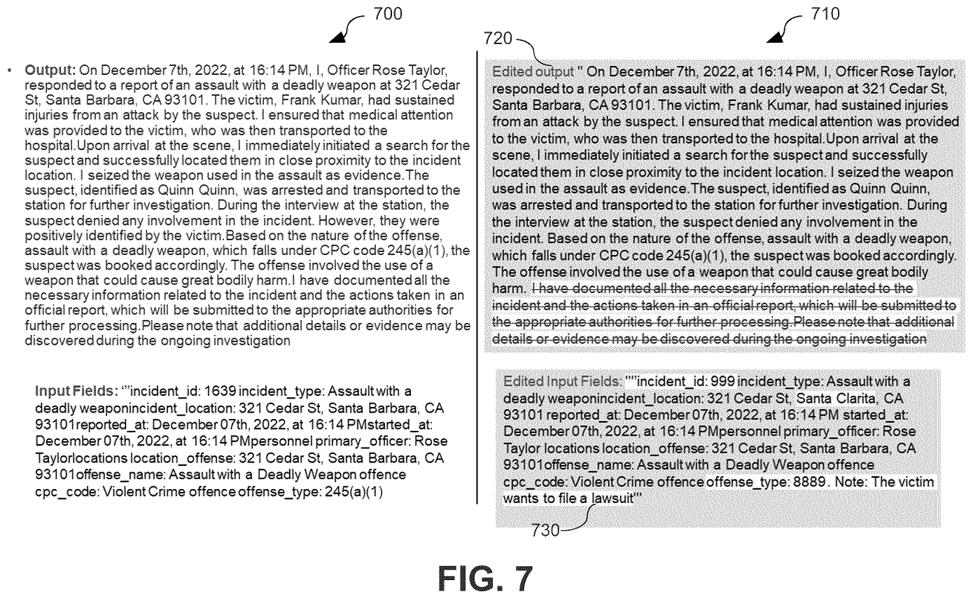

FIG. 7 illustrates an example first version 700 of a generated report 700 with corresponding feedback 710, which may be used to generate a second version of an incident report. In the example of FIG. 7, the first version of the report 700, can be created as a generated report 150 using the approach as described with respect to FIG. 1. When the first version of the incident report 700 is provided to the reporter interface 105, a user may use the reporter interface 105 to provide feedback 710 as described in FIG. 1 with relation to the revised inputs 155. The user may revise the text of the first version of the report 700, edit one or more of the input fields used to generate the first version of the report 700, or provide instructions to the LLM 130 for revising the report. In this example, the feedback 710 includes edited input fields 720 and edited output 730 from the first version of the report 700.

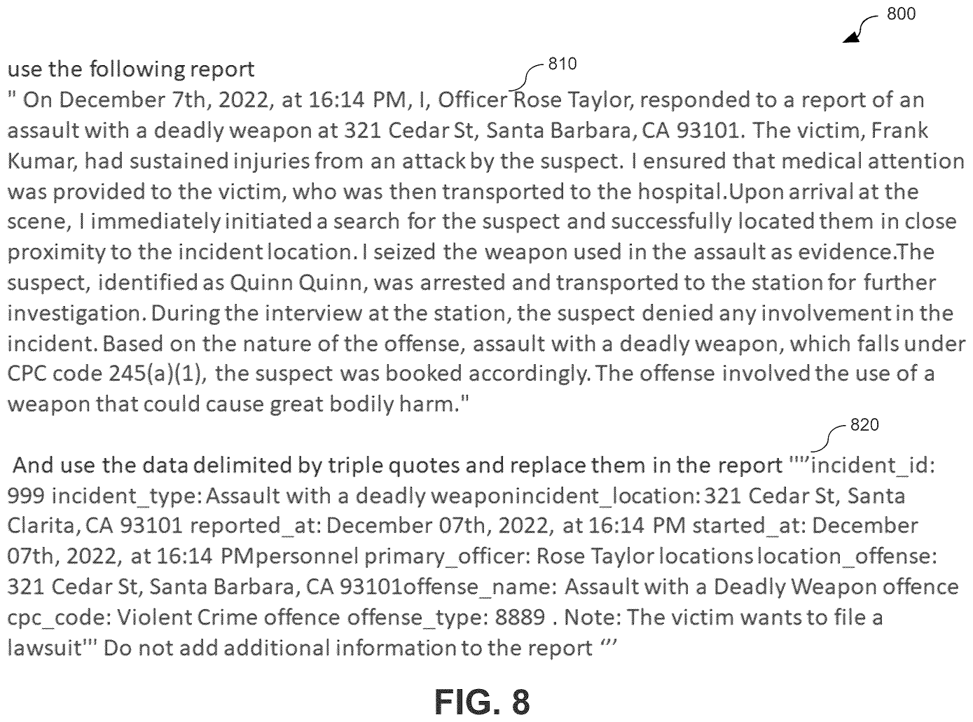

FIG. 8 illustrates an example prompt 800 to generate a second version of an incident report. The example prompt 800 may be generated based on the feedback 710 to the first version of the report 700 as shown in FIG. 7. An example report section 810 may include text corresponding to the edited output 730, which was modified from the first version of the report 700. A structured data section 820 may include the edited input fields 720 that were modified from those used to generate the first version of the report 700. The example prompt 800 may be provided to the LLM 130 to generate the second version of the report.

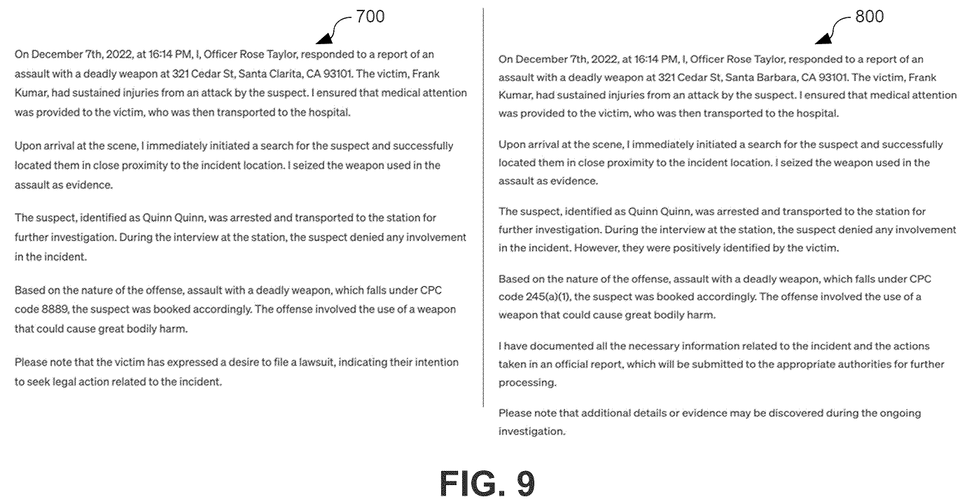

FIG. 9 illustrates a first version of a report 700 and a second version of the report 900. The first version of the report 700 in this example is that shown in FIG. 7, which was generated using the approach described in FIG. 1. The second version of the report 900 is generated using the example prompt 800 shown in FIG. 8. The second version of the report 900 is therefore generated based on the first version of the report 700, the edited input fields 720, and the edited output 730.

### Report Generation Flow

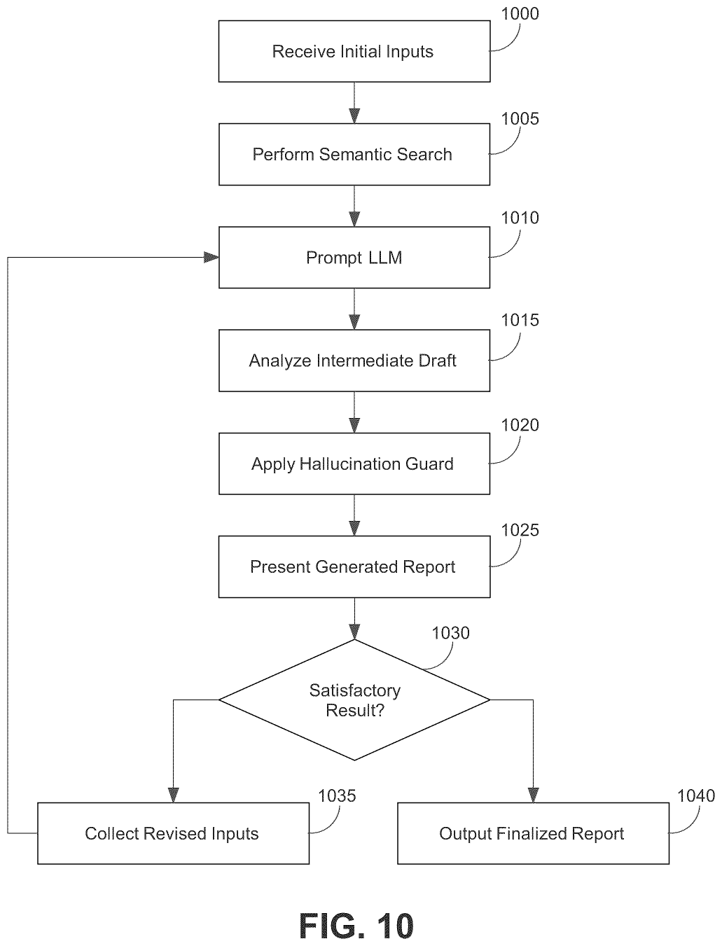

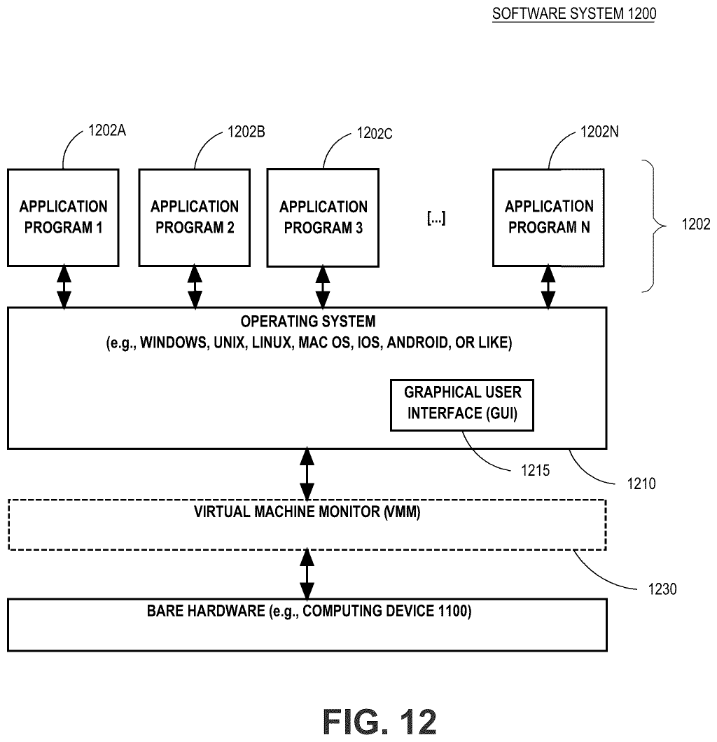

FIG. 10 is a flow diagram for an example approach to generating a report utilizing an LLM. The functionality described with respect to FIG. 10 can be provided, for example, by the architectures of FIG. 1, FIG. 2, FIG. 12 and/or FIG. 13.

At step 1000, the report generation platform 190 may receive initial inputs 110 from a reporter interface 105 to generate an incident report having a corresponding event type. In an example, the initial inputs 100 can be structured data, unstructured data, or a combination thereof. The initial inputs 100 can be received at the reporter device via, for example, a GUI or other mechanism(s) that allow a user to provide input to a computing environment.

At step 1005, the sematic search engine 120 performs a semantic search based on the initial inputs 100. In an example, the semantic search utilizes the initial inputs to retrieve one or more previously generated reports from a reports database 125 (or other repository) having a type matching the incident report. The semantic search engine 120 provides relevant examples that are selected from the reports database 125 as the closest examples to the type of incident report that is to be generated.

At step 1010, the LLM 130 may generate an intermediate draft version 135 of the incident report. The LLM receive a prompt this is based on the initial inputs 100 and results of the semantic search. The LLM 130 may use the retrieved one or more previously generated reports and at least a portion of the initial inputs 100 to generate an intermediate draft version of the incident report.

At step 1015, the hallucination gate 140 may analyze the intermediate draft version of the incident report to identify unreliable information. Various approaches to analyzing the intermediate draft version can be utilized including, for example, pattern recognition, heuristics, blacklists, etc.

At step 1020, the hallucination gate 140 may modify the intermediate draft version of the incident report using hallucination guards based on the analysis performed at step 1015. The hallucination gate 140 may thereby reduce the unreliable information to generate a reviewable draft version of the incident report. If the hallucination gate 140 did not identify unreliable information, however, this step may be omitted.

At step 1025, the report generation platform 190 may provide a reviewable draft version of the report to the reporter interface 105. The reporter interface 105 may in turn present the draft version to the user using, for example, a GUI, or any other appropriate interface supported by the reporter interface 105 that allows the user to review the report.

At step 1030, the report generation platform 190 may determine whether the version of the generated report 150 is satisfactory to the user of the reporter interface 105. The user can indicate whether or not the version of the generated report 150 is satisfactory by, for instance, interacting with a selectable component of the reporter interface 105. If the generated report is not satisfactory, then the process may proceed to step 1035. Otherwise, the process may proceed to step 1040.

At step 1035, if the generated report is not satisfactory, the reporter interface 105 obtains user generated input corresponding to the reviewable draft version via the user interface(s). The user generated input and the reviewable draft version of the report are provided as a prompt to the LLM 130, and the process proceeds back to step 1010 to cause the LLM 130 to generate an updated version of the incident report. The steps are then repeated until the report generation platform 190 determines that the generated report 150 is satisfactory at step 1030.

At step 1040, the report generation platform 190 may output the most recent version of the generated report 150 as the finalized report. The process may then proceed to completion.

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 12 is a block diagram that illustrates a computer system 1200 upon which an embodiment of the invention may be implemented. Computer system 1200 includes a bus 1202 or other communication mechanism for communicating information, and a hardware processor 1204 coupled with bus 1202 for processing information. Hardware processor 1204 may be, for example, a general-purpose microprocessor.

Computer system 1200 also includes a main memory 1206, such as a random-access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk, optical disk, or solid-state drive is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1210. Volatile media includes dynamic memory, such as main memory 1206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface ˜18 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the worldwide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

### Software Overview

FIG. 13 is a block diagram of a basic software system 1300 that may be employed for controlling the operation of computer system 1200. Software system 1300 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1300 is provided for directing the operation of computer system 1200. Software system 1300, which may be stored in system memory (RAM) 1206 and on fixed storage (e.g., hard disk or flash memory) 1210, includes a kernel or operating system (OS) 1310.

The OS 1310 manages low-level aspects of computer operation, including managing execution of processes, memory allocation, file input and output (I/O), and device I/O. One or more application programs, represented as 1302A, 1302B, 1302C . . . 1302N, may be “loaded” (e.g., transferred from fixed storage 1210 into memory 1206) for execution by the system 1300. The applications or other software intended for use on computer system 1200 may also be stored as a set of downloadable computer-executable instructions, for example, for downloading and installation from an Internet location (e.g., a Web server, an app store, or other online service).

Software system 1300 includes a graphical user interface (GUI) 1315, for receiving user commands and data in a graphical (e.g., “point-and-click” or “touch gesture”) fashion. These inputs, in turn, may be acted upon by the system 1300 in accordance with instructions from operating system 1310 and/or application(s) 1302. The GUI 1315 also serves to display the results of operation from the OS 1310 and application(s) 1302, whereupon the user may supply additional inputs or terminate the session (e.g., log off).

OS 1310 can execute directly on the bare hardware 1320 (e.g., processor(s) 1204) of computer system 1200. Alternatively, a hypervisor or virtual machine monitor (VMM) 1330 may be interposed between the bare hardware 1320 and the OS 1310. In this configuration, VMM 1330 acts as a software “cushion” or virtualization layer between the OS 1310 and the bare hardware 1320 of the computer system 1200.

VMM 1330 instantiates and runs one or more virtual machine instances (“guest machines”). Each guest machine comprises a “guest” operating system, such as OS 1310, and one or more applications, such as application(s) 1302, designed to execute on the guest operating system. The VMM 1330 presents the guest operating systems with a virtual operating platform and manages the execution of the guest operating systems.

In some instances, the VMM 1330 may allow a guest operating system to run as if it is running on the bare hardware 1320 of computer system 1200 directly. In these instances, the same version of the guest operating system configured to execute on the bare hardware 1320 directly may also execute on VMM 1330 without modification or reconfiguration. In other words, VMM 1330 may provide full hardware and CPU virtualization to a guest operating system in some instances.

In other instances, a guest operating system may be specially designed or configured to execute on VMM 1330 for efficiency. In these instances, the guest operating system is “aware” that it executes on a virtual machine monitor. In other words, VMM 1330 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

The above-described basic computer hardware and software is presented for the purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### CONCLUSION

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving one or more initial inputs from a user;
identifying one or more example incident reports;
sending, to a large language model (LLM), the one or more example incident reports and the one or more initial inputs;
accessing a reviewable version of an incident report that is based on output that the LLM generated based on the example incident reports and the one or more initial inputs;
presenting, in a human readable format via a graphical user interface (GUI), the reviewable version of the incident report;
receiving, via the GUI, a modification corresponding to the reviewable version of the incident report; and
sending, to the LLM, the modification and the reviewable version of the incident report to cause the LLM to generate an updated version of the incident report;
wherein the method is performed by one or more computing devices.

2. The method of claim 1, wherein sending, to the LLM, the modification and the reviewable version of the incident report to cause the LLM to generate the updated version of the incident report further comprises adjusting one or more temperature hyperparameters of the LLM.

3. The method of claim 1, wherein the one or more initial inputs comprise at least unstructured text and structured data.

4. The method of claim 3, further comprising receiving, via one or more input fields of the GUI, the structured data.

5. The method of claim 1, wherein identifying the one or more example incident reports comprises performing a semantic search of a reports data store based at least in part on the one or more initial inputs.

6. The method of claim 5, wherein the performing the semantic search based at least in part on the initial inputs comprises selecting the one or more example incident reports based at least in part on a centroid or clustering analysis.

7. The method of claim 1, wherein the incident report comprises a police report, an inspection report, or an insurance report.

8. The method of claim 1, further comprising:
identifying hallucinatory content in an intermediate version of the incident report, the intermediate version of the incident report being generated by the LLM based at least in part on the one or more example incident reports and the at least a portion of the one or more initial inputs; and
generating the reviewable version of the incident report, the reviewable version of the incident report excluding the hallucinatory content.

9. The method of claim 8, wherein the hallucinatory content in the intermediate version of the incident report is identified based at least in part on one or more of: contextual analysis, heuristics-based analysis, or pattern recognition.

10. The method of claim 1, further comprising:
identifying a prompt based at least in part on the one or more initial inputs; and
sending the prompt to the LLM.

11. One or more non-transitory storage media storing instructions which, when executed by one or more computing devices, cause:
receiving one or more initial inputs from a user;
identifying one or more example incident reports;
sending, to a large language model (LLM), the one or more example incident reports and the one or more initial inputs;
accessing a reviewable version of an incident report that is based on output that the LLM generated based on the example incident reports and the one or more initial inputs;
presenting, in a human readable format via a graphical user interface (GUI), the reviewable version of the incident report;
receiving, via the GUI, a modification corresponding to the reviewable version of the incident report; and
sending, to the LLM, the modification and the reviewable version of the incident report to cause the LLM to generate an updated version of the incident report.

12. The one or more non-transitory storage media of claim 11, wherein the instructions that cause sending, to the LLM, the modification and the reviewable version of the incident report to cause the LLM to generate the updated version of the incident report, when executed by the one or more computing devices, further cause adjusting one or more temperature hyperparameters of the LLM.

13. The one or more non-transitory storage media of claim 11, wherein the one or more initial inputs comprise at least unstructured text and structured data.

14. The one or more non-transitory storage media of claim 13, wherein the instructions, when executed by the one or more computing devices, further cause receiving, via one or more input fields of the GUI, the structured data.

15. The one or more non-transitory storage media of claim 11, wherein the instructions causing identifying the one or more example incident reports, when executed by the one or more computing devices, further cause performing a semantic search of a reports data store based at least in part on the one or more initial inputs.

16. The one or more non-transitory storage media of claim 15, wherein the performing the semantic search based at least in part on the initial inputs comprises selecting the one or more example incident reports based at least in part on a centroid or clustering analysis.

17. The one or more non-transitory storage media of claim 11, wherein the incident report comprises a police report, an inspection report, or an insurance report.

18. The one or more non-transitory storage media of claim 11, wherein the instructions, when executed by the one or more computing devices, further cause:
identifying hallucinatory content in an intermediate version of the incident report, the intermediate version of the incident report being generated by the LLM based at least in part on the one or more example incident reports and the at least a portion of the one or more initial inputs; and
generating the reviewable version of the incident report, the reviewable version of the incident report excluding the hallucinatory content.

19. The one or more non-transitory storage media of claim 18, wherein the hallucinatory content in the intermediate version of the incident report is identified based at least in part on one or more of: contextual analysis, heuristics-based analysis, or pattern recognition.

20. The one or more non-transitory storage media of claim 11, wherein the instructions, when executed by the one or more computing devices, further cause:
identifying a prompt based at least in part on the one or more initial inputs; and
sending the prompt to the LLM.
